(19) United States
(12) Patent Application Publication
(10) Pub. No.: US 2016/0103478 A1
(43) Pub. Date: Apr. 14, 2016

(54) MEMORY SYSTEM AND MEMORY CONTROLLER

(71) Applicant: Kabushiki Kaisha Toshiba, Minato-ku (JP)

(72) Inventors: Yu NAKANISHI, Yokohama (JP); Tetsuya Sunata, Kawasaki (JP); Atsushi Shiraishi, Kawasaki (JP); Fumio Hara, Yokohama (JP); Keigo Hara, Ota (JP); Takaya Horiki, Kawasaki (JP); Daisuke Iwai, Yokohama (JP); Takashi Ogasawara, Yokohama (JP); Yasuyuki Ueda, Kawasaki (JP)

(73) Assignee: Kabushiki Kaisha Toshiba, Minato-ku (JP)

(21) Appl. No.: 14/636,567

(22) Filed: Mar. 3, 2015

Related U.S. Application Data
(60) Provisional application No. 62/061,549, filed on Oct. 8, 2014.

(51) Int. Cl. G06F 1/32

(52) U.S. Cl. CPC G06F 1/3287; G06F 1/3293; G06F 1/3275

(57) ABSTRACT

According to embodiments, a second control unit creates parity from information loaded into a volatile second memory. When shifting from a normal mode to a sleep mode, the second control unit stores the created parity and the information loaded in the second memory into a buffer of a non-volatile first memory, and issues a power supply shutdown request. A power supply circuit shuts down power supply to the second memory and the second control unit in response to the issued power supply shutdown request.

### CROSS-REFERENCE TO RELATED APPLICATIONS

This application is based upon and claims the benefit of priority from U.S. Provisional Application No. 62/061,549, filed on Oct. 8, 2014; the entire contents of which are incorporated herein by reference.

### FIELD

Embodiments relate generally to a memory system provided with a non-volatile memory and a memory controller which controls the non-volatile memory.

### BACKGROUND

In a storage system provided with a non-volatile memory such as a flash memory, management information stored in the non-volatile memory is loaded into a volatile memory at time of startup of the storage system. Thereafter, the management information is updated in association with writing of data to the non-volatile memory.

There is a method of writing the management information to the non-volatile memory and shutting down power supply to the volatile memory and the non-volatile memory when the storage system shifts from a normal mode to a sleep mode being a power-saving standby power mode. Power consumption in the sleep mode is reduced by the method. However, a power supply shutdown process and a power supply restoring process of the non-volatile memory, and a reading/writing process from/to the non-volatile memory take time, so that a method of efficiently restoring from the sleep mode to the normal mode is desired.

### BRIEF DESCRIPTION OF THE DRAWINGS

FIG. 1 is a functional block diagram illustrating an internal configuration of a memory system;

FIG. 2 is a view illustrating an internal configuration of a memory chip;

FIG. 3 is a flowchart illustrating an operational procedure of the memory system of a first embodiment;

FIG. 4 is a flowchart illustrating a detailed procedure of a shifting process to a standby mode;

FIG. 5 is a schematic diagram illustrating the shifting process to the standby mode;

FIG. 6 is a flowchart illustrating an operational procedure of the memory system when a restoration request is received;

FIG. 7 is a flowchart illustrating a detailed procedure of a shifting process to a normal mode;

FIG. 8 is a flowchart illustrating an operational procedure of a memory system of a second embodiment; and

FIG. 9 is a flowchart illustrating an operational procedure of the memory system when a command is received.

### DETAILED DESCRIPTION

According to the embodiments, a memory system includes a non-volatile first memory, a volatile second memory, a first control unit, a second control unit, and a power supply circuit. The first control unit communicates with a host. The second control unit loads information stored in the first memory into the second memory. when shifting from a normal mode to a sleep mode, the second control unit creates parity from the information loaded in the second memory, stores the created parity and the information loaded in the second memory into the buffer of the first memory, and issues a power supply shutdown request. The power supply circuit shuts down power supply to the second memory and the second control unit in response to the issued power supply shutdown request.

The memory system and a memory controller according to the embodiments are hereinafter described in detail with reference to the attached drawings. Meanwhile, the present invention is not limited by the embodiments.

### First Embodiment

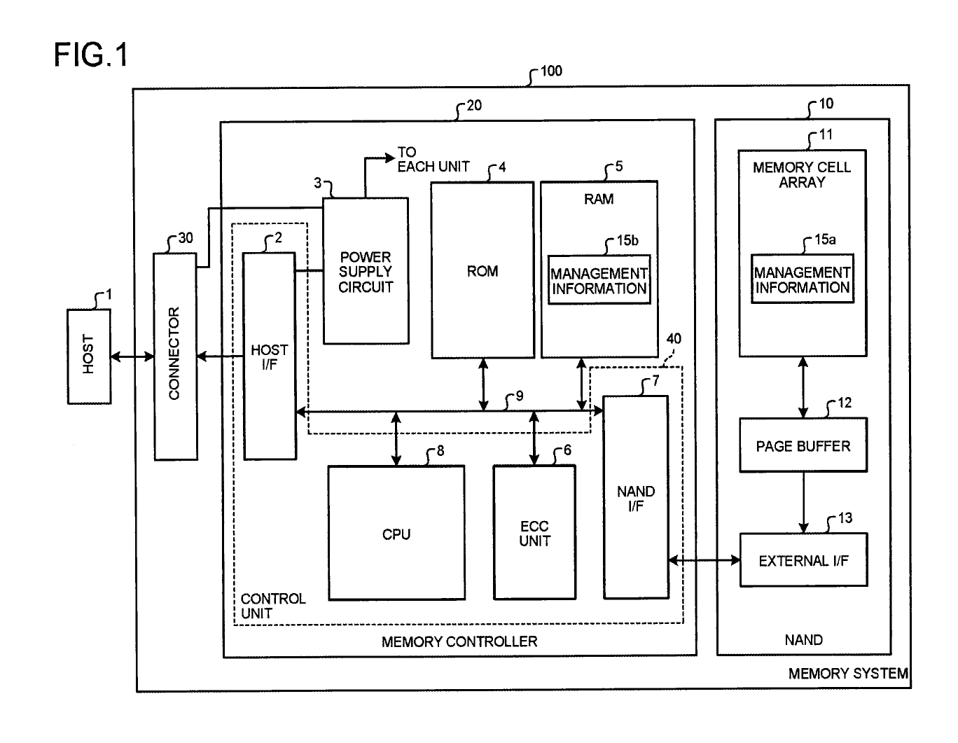

FIG. 1 is a block diagram illustrating a configuration example of a memory system 100 of a first embodiment. The memory system 100 is provided with a NAND flash memory (hereinafter, abbreviated as NAND) 10 as a non-volatile memory, a memory controller 20, and a connector 30. The non-volatile memory may also be a memory other than the NAND such as a three-dimensional structure flash memory, a ReRAM (resistance random access memory), a FeRAM (ferroelectric random access memory). The memory system 100 may be applied to various standards including UFS (universal flash storage), for example.

The memory system 100 is connected to a host device (hereinafter, abbreviated as host) 1 through the connector 30 to serve as an external storage device of the host 1. The host 1 is a personal computer, a cell phone, an imaging device and the like, for example.

The connector 30 is connected to a host I/F 2 of the memory controller 20 to perform a process according to an interface standard between the same and the host device 1 and output a read command, a write command, user data and the like received from the host device 1 to the host I/F 2. The connector 30 also transmits the user data read from the NAND 10 and a response from the memory controller 20 to the host 1.

The NAND 10 includes one or a plurality of memory chips. FIG. 1 illustrates a case in which the NAND 10 includes one memory chip. The memory chip includes a memory cell array 11, a page buffer 12, an external interface 13, and a peripheral circuit not illustrated. The memory cell array 11 includes a plurality of memory cells arranged in a matrix. In the NAND 10, in general, writing and reading are performed in data unit referred to as a page and erasing is performed in data unit referred to as a block BLK. The peripheral circuit not illustrated is provided with a circuit required for performing the reading, the writing, and the erasing of the data on the memory cell array 11, such as a decoder which decodes an address, a word line driver which controls a voltage of a word line, and a sense amplifier which detects the data from a bit line, for example.

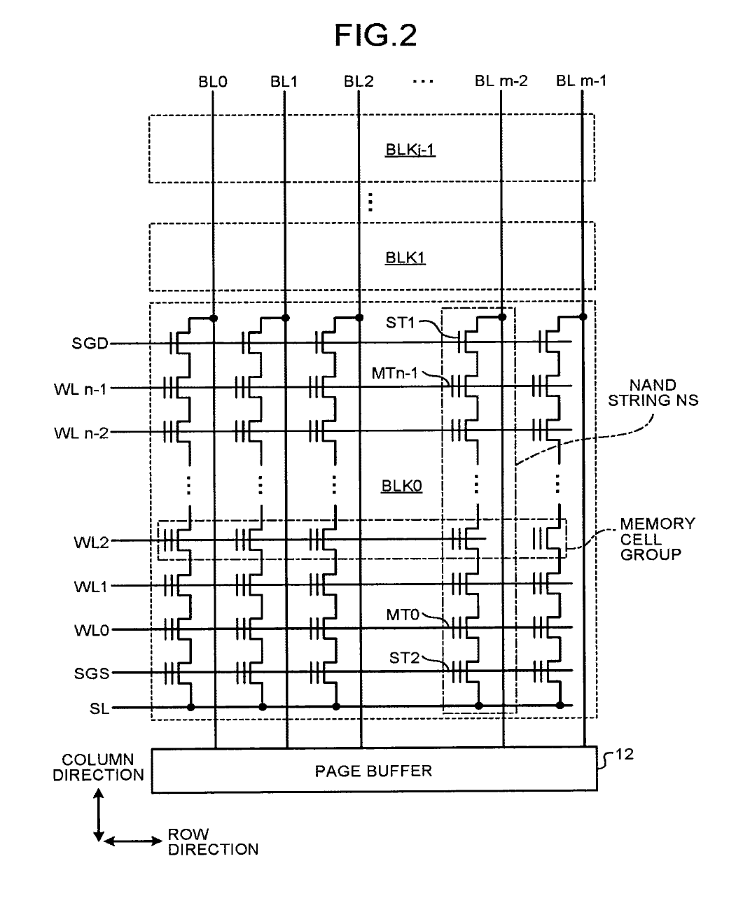

FIG. 2 is a circuit diagram illustrating a configuration of the NAND 10. The memory cell array 11 is provided with j blocks BLK0 to BLKj-1 (j is an integer not smaller than one). Each block BLK is provided with m (m is an integer not smaller than one) NAND strings NSs sequentially arranged in a row direction. Each NAND string NS includes n (n is an integer not smaller than one) memory cell transistors MT0 to MTn-1 connected in series such that adjacent memory cell transistors MTs share a diffusion region (source region or drain region) and selection transistors ST1 and ST2 arranged on both ends of a column of the n memory cell transistors MT0 to MTn-1.

Word lines WL0 to WLn are connected to control gate electrodes of the memory cell transistors MT0 to MTn forming the NAND string NS, respectively, and the memory cell transistors MTi (i=0 to n) of respective NAND strings NSs are commonly connected to the same word line WLi (i=0 to n). That is to say, the control gate electrodes of the memory cell transistors MTi in the same row in the block BLK are connected to the same word line WLi.

Each of the memory cell transistors MT0 to MTn-1 is formed of a field-effect transistor including a stacked gate structure formed on a semiconductor substrate. The stacked gate structure includes a charge accumulation layer (floating gate electrode) formed on the semiconductor substrate with a gate insulating film interposed therebetween and the control gate electrode formed on the charge accumulation layer with an inter-gate insulating film interposed therebetween. The memory cell transistors MT0 to MTn-1 with threshold voltages changing according to the number of electrons accumulated in the floating gate electrode may store the data according to difference in threshold voltage.

Bit lines BL0 to BLm-1 are connected to drains of m selection transistors ST1 in one block BLK, respectively, and a selection gate line SGD is connected to gates thereof in common. A source of the selection transistor ST1 is connected to a drain of the memory cell transistor MTn-1. Similarly, a source line SL is connected to sources of m selection transistors ST2 in one block BLK in common and a selection gate line SGS is connected to gates thereof in common. A drain of the selection transistor ST2 is connected to a source of the memory cell transistor MT0.

In this embodiment, m memory cell transistors MTi connected to the same word line WLi are referred to as a memory cell group. When the memory cell is a single-level cell (SLC), one memory cell group corresponds to one page. When the memory cell is a multi-level cell (MLC), one memory cell group corresponds to a plurality of pages. Each memory cell is connected to the word line and the bit line. Each memory cell may be identified by the address which identifies the word line and the address which identifies the bit line.

The bit lines BL0 to BLm-1 are connected to the page buffer 12 through the sense amplifier (not illustrated). As described above, the data is written to and read from the NAND 10 in the page unit, so that at least one page buffer 12 having a capacity capable of storing the data of one page is required. The page buffer 12 is a volatile memory and this may perform a writing operation and a reading operation at a higher rate than in the memory cell array 11.

The page buffer 12 temporarily stores read data of one page read from the memory cell array 11. The read data of one page stored in the page buffer 12 is transmitted to the memory controller 20 through the external interface 13. The page buffer 12 temporarily stores write data of one page transmitted from the memory controller 20 through the external interface 13. The write data of one page stored in the page buffer 12 is written to the memory cell array 11. Although a case in which one page buffer 12 is provided is hereinafter described for simple description, it is also possible that a plurality of stages of page buffers 12 is provided.

The memory controller 20 includes a power supply circuit 3, a ROM (read only memory) 4, a RAM (random access memory) 5, a control unit 40, and an internal bus 9. The control unit 40 includes the host interface 2, an ECC (error correcting code) unit 6, a NAND interface 7, a CPU (central processing unit) 8, and various hardware circuits.

The host I/F 2 communicates with the host 1 through the connector 30. The host I/F 2 outputs the command, the user data (write data) and the like received from the host 1 to the internal bus 9. The host I/F 2 also transmits the user data read from the NAND 10, the response from the CPU 8 and the like to the host 1. The NAND I/F 7 executes a process to write the user data and the like to the NAND 10, a reading process from the NAND 10 and the like based on an instruction of the CPU 8.

The ROM 4 stores a boot program for reading firmware FW1 stored in the memory cell array 11 of the NAND 10 and firmware FW2. In this embodiment, the firmware is formed of the firmware FW1 stored in the NAND 10 and the firmware FW2 stored in the ROM 4. For example, the firmware FW2 stored in the ROM 4 is formed of a program, modification or updating of which is not required, and the firmware FW1 stored in the NAND 10 is formed of a program which might be modified or updated. Meanwhile, the firmware may be entirely stored in the memory cell array 11 of the NAND 10.

The RAM 5 is a volatile semiconductor memory, access to which may be higher than that to the NAND 10. An SRAM (static random access memory) and a DRAM (dynamic random access memory) are used as the RAM 5. The RAM 5 temporarily stores the firmware FW1 stored in the NAND 10. That is to say, the firmware FW1 is read from the NAND 10 to be loaded into the RAM 5 at time of startup of the memory system 100.

The RAM 30 temporarily stores the user data received from the host 1 before the user data is written to the NAND 10. The RAM 30 temporarily stores the user data read from the NAND 10 before the user data is transmitted to the host 1.

The RAM 30 temporarily stores management information 15b which manages the user data and the memory system 100. The management information 15b managed by the RAM 30 is backed up as management information 15a by the NAND 10. At time of startup of the memory system 100, the firmware FW1 is read from the NAND 10 to be loaded into the RAM 5. At the time of an initializing process of the CPU 8, the management information 15a is read from the NAND 10 to be loaded into the RAM 5 as the management information 15b.

The management information 15b includes address translation information, block management information and the like. The address translation information is a mapping table which manages relationship between a logical address specified by the host 1 and a storage position (physical address) of the NAND 10. The block management information is the information for managing a plurality of blocks BLKs included in the NAND 10. The block management information includes bad block management information, erasing count management information, use state management information and the like. The bad block management information manages an unusable defective block which does not normally operate for various reasons. The erasing count management information manages an erasing count of each block. The use state management information identifies whether each block is an active block or a free block. The active block is the block in which valid data is recorded. The free block is the block in which valid data is not recorded. The free block is reusable after being erased.

The ECC unit 6 encodes the user data to generate parity. The ECC unit 6 also encodes the management information 15b to generate the parity. The ECC unit 6 may use any code as an encoding method; this may use a BCH code, an RS (Reed-Solomon) code and the like, for example. The ECC unit 6 performs a decoding process based on the user data read from the NAND 10 and the parity. The ECC unit 6 also performs the decoding process based on the management information read from the NAND 10 and the parity. The ECC unit 6 directly outputs the user data or the management information read from the NAND 10 to the internal bus 9 when there is no error in the user data or the management data, or outputs the user data or the management information to the internal bus 9 after correcting the error by using the parity when there is the error in the user data or the management data.

The CPU 8 generally controls the memory system 100. The firmware FW1 loaded into the RAM 5 and the firmware FW2 stored in the ROM 4 are executed, so that a function of the CPU 8 is realized. When the CPU 8 receives the command from the host 1 through the host I/F 2, the CPU 8 controls according to the command. For example, when the CPU 8 receives a write request from the host 1, the CPU 8 instructs the ECC unit 6 to encode the write data. The CPU 8 also instructs the NAND I/F 7 to write a code word (data and parity) generated by the ECC unit 6 to the NAND 10. In association with this writing, the management information 15b managed by the RAM 5 is updated. When the CPU 8 receives a read request from the host 1, the CPU 8 instructs the NAND I/F 7 to read the code word (user data and parity) from the NAND 10 based on the management information 15b managed by the RAM 5. The CPU 8 also instructs the ECC unit 6 to decode the code word read from the NAND 10. The CPU 8 also instructs the host I/F 2 to transmit the decoded user data to the host 1.

DC power supplied from the host 1 is input to the power supply circuit 3 through the connector 30. The power supply circuit 3 generates internal DC power having a plurality of different voltages from the external DC power and supplies the internal DC power to each unit in the memory system 100 through an internal power supply line. The power supply circuit 3 detects rising or trailing of the external power and generates a power-on reset signal or a power-off reset signal to supply to the CPU 8 and the like. Meanwhile, the power supply circuit 3 may include the internal power.

The power supply circuit 3 may separately supply the internal DC power to the NAND 10 and the memory controller 20. The power supply circuit 3 may separately supply the internal DC power to the host I/F 2 being a partial circuit and the circuit other than the host I/F 2 in the memory controller 20. In the memory system 100, standby electricity of the NAND 10 is smaller than that of the memory controller 20.

The memory system 100 has two states: a normal mode in which a normal operation may be performed and a sleep mode being a power-saving standby power mode. In this embodiment, the management information 15b stored in the RAM 5 is stored in the page buffer 12 of the NAND 10 before the memory system 100 shifts from the normal mode to the sleep mode. In this embodiment, the parity of the management information 15b is created and the management information 15b is stored in the page buffer 12 together with the parity, so that reliability of the management information is improved. In the sleep mode, the power is continuously supplied to the NAND 10 but the power supply to a large part of the circuits in the memory controller 20 (circuits other than the host I/F 2 and the power supply circuit 3) is shut down, so that the standby electricity in the sleep mode is reduced. In this embodiment, the management information is stored in the page buffer 12 of the NAND 10, so that the management information may be read in a shorter time than in a case in which the management information is read from the memory cell array 11 at the time of restoration to the normal mode.

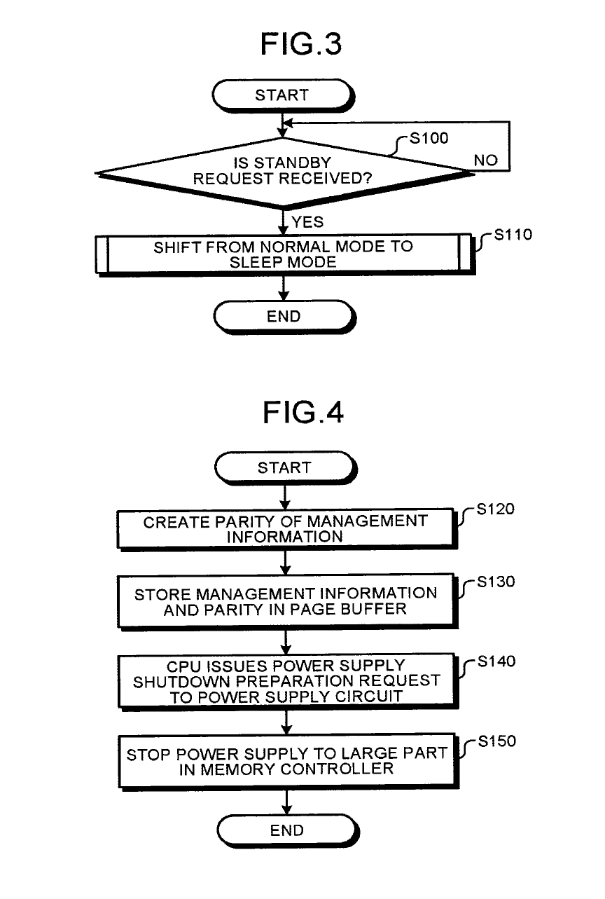

FIG. 3 illustrates a shifting procedure from the normal mode to the sleep mode of the first embodiment. When the host I/F 2 receives a standby request from the host 1 through the connector 30 (step S100), the host I/F 2 notifies the CPU 8 of the standby request. When the CPU 8 is notified of the standby request, the CPU 8 executes a shifting process from the normal mode to the sleep mode (step S110).

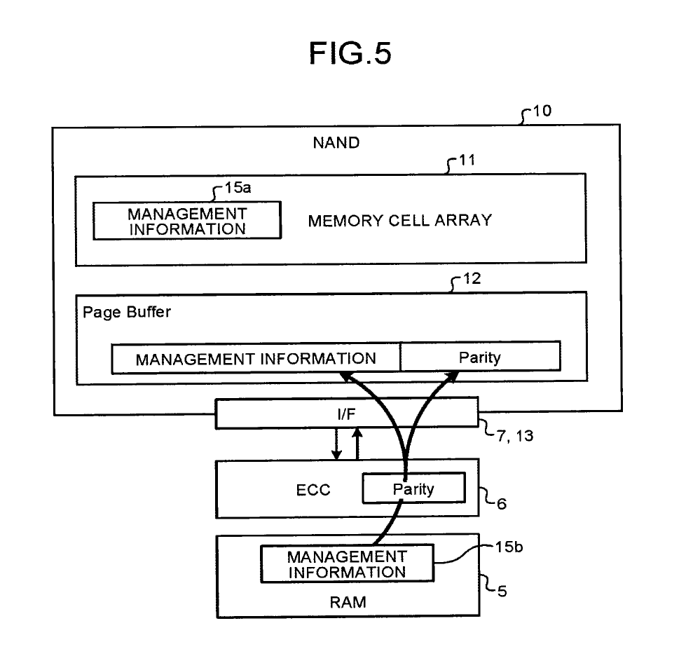

FIG. 4 illustrates a detailed procedure of the shifting process to the sleep mode. The CPU 8 instructs the ECC unit 6 to encode the management information 15b stored in the RAM 5. The CPU 8 also instructs the NAND I/F 7 to write the code word generated by the ECC unit 6 to the NAND 10. The ECC unit 6 creates the parity of the management information 15b read from the RAM 5 and outputs the code word including the created parity and the management information 15b to the NAND I/F 7 (step S120). The NAND I/F 7 outputs an instruction to write to the page buffer 12 to the NAND 10 and outputs the code word including the parity and the management information to the NAND 10. According to this, the peripheral circuit in the NAND 10 buffers the code word including the parity and the management information received through the external I/F 13 in the page buffer 12 (step S130). FIG. 5 illustrates a saving process of the management information 15b of this embodiment in which the management information 15b and the parity are stored in the page buffer 12 of the NAND 10. Meanwhile, when the user data is buffered in the RAM 5, the user data is stored in the memory cell array of the NAND 10 together with the parity.

When the saving process in the NAND 10 is finished, the CPU 8 issues a power supply shutdown preparation request to the power supply circuit 3 (step S140). The power supply shutdown preparation request is the request to shut down the power supply to a specified circuit when the CPU 8 enters the sleep mode. The specified circuit to which the power supply is shut down is the circuits other than the host I/F 2 and the power supply circuit 3 in the memory controller 20. That is to say, the power is continuously supplied to the connector 30, the NAND 10, the host I/F 2, and the power supply circuit 3 and the power supply to the CPU 8, the ROM 4, the RAM 5, the ECC unit 6, and the NAND I/F 7 in the memory controller 20 is shut down.

When the power supply circuit 3 detects that the CPU 8 enters the sleep mode, the power supply circuit 3 continuously supplies the power to the connector 30, the NAND 10, the host I/F 2, and the power supply circuit 3 and shuts down the power supply to the CPU 8, the ROM 4, the RAM 5, the ECC unit 6, and the NAND I/F 7 in the memory controller 20 (step S150). As a result, the firmware FW1 and the management information stored in the RAM 5 are volatilized. The power is continuously supplied to the NAND 10, so that the management information 15b and the parity stored in the page buffer 12 are not volatilized. The host I/F 2 and the power supply circuit 3 in the memory controller 20 are continuously operated.

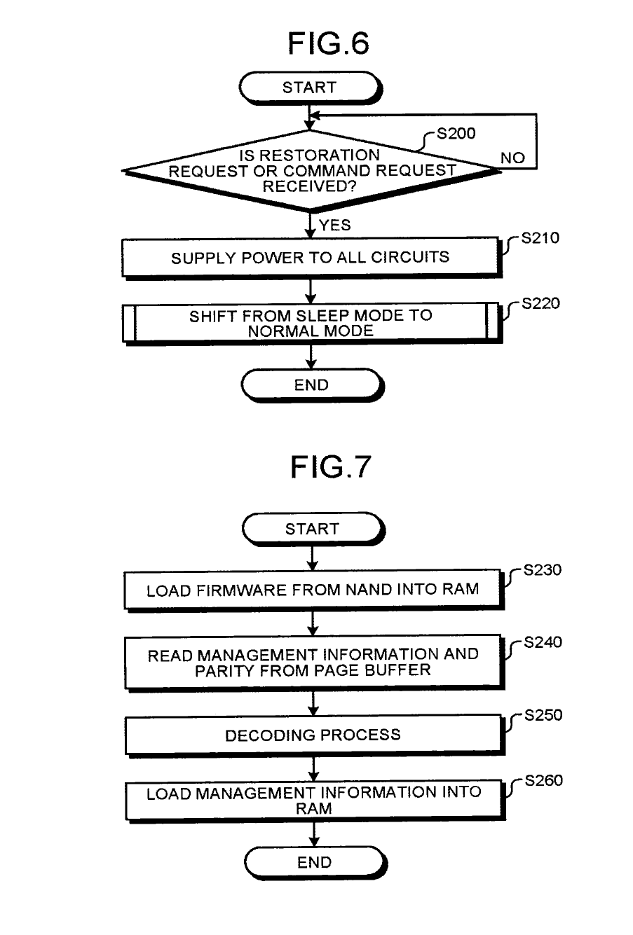

FIG. 6 illustrates a shifting procedure from the sleep mode to the normal mode. When the host I/F 2 receives a restoration request or a command from the host 1 through the connector 30 in the sleep mode (step S200), the host I/F 2 issues a power supply restoration request to the power supply circuit 3. When the power supply circuit 3 receives the power supply restoration request, the power supply circuit 3 supplies the power to all the circuits in the memory system 100 (step S210). That is to say, the power supply circuit 3 starts supplying the power again to the CPU 8, the ROM 4, the RAM 5, the ECC unit 6, and the NAND I/F 7 in the memory controller 20 to which the power supply is shut down. The host I/F 2 notifies the CPU 8 of reception of the restoration request or the command from the host 1. According to this notification, the CPU 8 is started to execute the following procedure.

After being started, the CPU 8 executes the boot program and the firmware FW2 stored in the ROM 4 and instructs the NAND I/F 7 to load the firmware FW1 stored in the memory cell array 11 of the NAND 10 into the RAM. The NAND I/F 7 reads the firmware FW1 stored in the memory cell array 11 of the NAND 10 and loads the read firmware FW1 into the RAM 5 (step S230). Thereafter, the CPU 8 executes the firmware FW1 stored in the RAM 5 and the firmware FW2 stored in the ROM 4, thereby executing the following procedure.

The CPU 8 instructs the NAND I/F 7 to read the management information 15b and the parity from the page buffer 12 of the NAND 10. The NAND I/F 7 outputs an instruction to read from the page buffer 12 to the NAND 10. According to this, the peripheral circuit in the NAND 10 reads the management information 15b and the parity buffered in the page buffer 12 and outputs the read management information 15b and parity to the NAND I/F 7 through the external I/F 13. The NAND I/F 7 outputs the management information 15b and the parity read from the NAND 10 to the ECC unit 6.

The ECC unit 6 performs the decoding process of the read management information 15b and parity (step S250). That is to say, the ECC unit 6 determines whether there is the error in the read management information 15b and corrects the error in the read management information by using the parity when there is the error. The ECC unit 6 loads the decoded management information 15b into the RAM 5 (step S260).

In this manner, in the first embodiment, when the standby request is received from the host 1, the management information stored in the RAM 5 is stored in the page buffer 12 of the NAND 10 together with the parity, and then the power supply to the circuits other than the circuit which communicates with the host 1 in the memory controller 20 is shut down. Therefore, in the first embodiment, it becomes possible to reduce the standby electricity in the sleep mode and to read/write the management information from/to the NAND 10 in a short time. Furthermore, it becomes possible to improve the reliability of the management information and to prevent the system from falling into an abnormal state by broken management information.

Meanwhile, it is also possible, when shifting to the sleep mode, to store the management information 15b stored in the RAM 5 into the page buffer 12 of the NAND 10 without the parity.

### Second Embodiment

In a second embodiment, a. CPU 8 shifts to a sleep mode by CPU's own judgment.

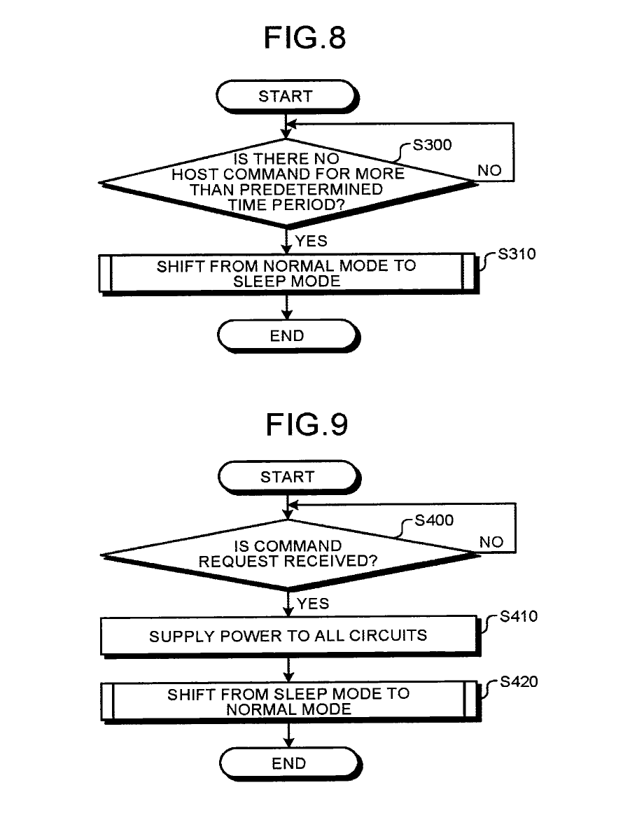

FIG. 8 illustrates a shifting procedure from a normal mode to the sleep mode of the second embodiment. The CPU 8 monitors a command from a host 1 (step S300) and when the CPU 8 detects that the command from the host 1 is not received for more than a certain time period (Yes at step S300), the CPU 8 executes the shifting procedure to the sleep mode illustrated in FIG. 4 (step S310). When the shifting procedure to the sleep mode is executed, management information 15b and parity are stored in a page buffer 12 of a NAND 10, power is continuously supplied to a connector 30, the NAND 10, a host I/F 2 and a power supply circuit 3, and the power supply to the CPU 8, a ROM 4, a RAM 5, an ECC unit 6, and a NAND I/F 7 in a memory controller 20 is shut down.

FIG. 9 illustrates a shifting procedure from the sleep mode to the normal mode of the second embodiment. When the host I/F 2 receives the command from the host 1 through the connector 30 in the sleep mode (step S400), the host I/F 2 issues a power supply restoration request to the power supply circuit 3. The power supply circuit 3 supplies the power to all the circuits in a memory system 100 by the power supply restoration request (step S410). Thereafter, the shifting procedure to the normal mode illustrated in FIG. 7 is executed (step S420). According to this, firmware stored in a memory cell array 11 of the NAND 10 is read to be loaded into the RAM 5 and the management information and the parity stored in the page buffer 12 of the NAND 10 are read to be loaded into the RAM 5.

In this manner, in the second embodiment, the CPU 8 is configured to shift to the sleep mode by CPU's own judgment. Therefore, it becomes possible to reduce standby electricity of the memory system 100 without using a standby request from the host 1 and to realize a storage system in which required time for storing and restoring the management information is shortened.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A memory system comprising:
a non-volatile first memory including a memory cell array and a buffer, the memory cell array including a plurality of memory cells;
a volatile second memory;
a first control unit which communicates with a host;
a second control unit configured to
load information stored in the first memory into the second memory,
when shifting from a normal mode to a sleep mode, create parity from the information loaded in the second memory, store the created parity and the information loaded in the second memory into the buffer of the first memory, and issue a power supply shutdown request; and
a power supply circuit which shuts down power supply to the second memory and the second control unit in response to the issued power supply shutdown request.

2. The memory system according to claim 1, wherein the information is management information.

3. The memory system according to claim 2, wherein
the second control unit shifts from the normal mode to the sleep mode in response to a standby request from the host.

4. The memory system according to claim 2, wherein
the second control unit shifts from the normal mode to the sleep mode when a command is not received from the host for more than a certain time period.

5. The memory system according to claim 3, wherein
the first control unit is configured to issue a power supply restoration request to the power supply circuit in response to a restoration request from the host, and the power supply circuit restarts supplying the power to the second memory and the second control unit in response to the issued power supply restoration request.

6. The memory system according to claim 5, wherein
the second control unit is configured to
after the power supply is restarted,
read the information and the parity stored in the buffer of the first memory,
decode the read information by using the read parity, and
load the decoded information into the second memory.

7. The memory system according to claim 6, wherein
the second control unit is configured to
after loading firmware stored in the memory cell array of the first memory into the second memory, read the information and the parity from the first memory.

8. The memory system according to claim 4, wherein
the first control unit is configured to issue a power supply restoration request to the power supply circuit in response to the command from the host, and the power supply circuit restarts supplying the power to the second memory and the second control unit in response to the issued power supply restoration request, and
the second control unit is configured to
read the information and the parity stored in the buffer of the first memory,
decode the read information by using the read parity, and
load the decoded information into the second memory.

9. The memory system according to claim 8, wherein
the second control unit is configured to
after loading firmware stored in the memory cell array of the first memory into the second memory, read the information and the parity from the first memory.

10. The memory system according to claim 2, wherein
the management information includes address translation information indicating correspondence relationship between a logical address specified by the host and a physical address in the memory cell array.

11. A memory controller which controls a non-volatile first memory including a memory cell array and a buffer, the memory cell array including a plurality of memory cells, the memory controller comprising:
a volatile second memory;
a first control unit which communicates with a host;
a second control unit configured to
load information stored in the first memory into the second memory,
when shifting from a normal mode to a sleep mode, create parity from the information loaded in the second memory, store the created parity and the information loaded in the second memory into the buffer of the first memory, and issue a power supply shutdown request; and
a power supply circuit which shuts down power supply to the second memory and the second control unit in response to the issued power supply shutdown request.

12. The memory controller according to claim 11, wherein the information is management information.

13. The memory controller according to claim 12, wherein
the second control unit shifts from the normal mode to the sleep mode in response to a standby request from the host.

14. The memory controller according to claim 12, wherein
the second control unit shifts from the normal mode to the sleep mode when a command is not received from the host for more than a certain time period.

15. The memory controller according to claim 13, wherein
the first control unit is configured to issue a power supply restoration request to the power supply circuit in response to a restoration request from the host, and the power supply circuit restarts supplying the power to the second memory and the second control unit in response to the issued power supply restoration request.

16. The memory controller according to claim 15, wherein
the second control unit is configured to
after the power supply is restarted,
read the information and the parity stored in the buffer of the first memory,
decode the read information by using the read parity, and
load the decoded information into the second memory.

17. The memory controller according to claim 16, wherein
the second control unit is configured to
after loading firmware stored in the memory cell array of the first memory into the second memory, read the information and the parity from the first memory.

18. The memory controller according to claim 14, wherein
the first control unit is configured to issue a power supply restoration request to the power supply circuit in response to the command from the host, and the power supply circuit restarts supplying the power to the second memory and the second control unit in response to the issued power supply restoration request, and
the second control unit is configured to
read the information and the parity stored in the buffer of the first memory,
decode the read information by using the read parity, and
load the decoded information into the second memory.

19. The memory controller according to claim 18, wherein
the second control unit is configured to
after loading firmware stored in the memory cell array of the first memory into the second memory, read the information and the parity from the first memory.

20. The memory controller according to claim 12, wherein
the management information includes address translation information indicating correspondence relationship between a logical address specified by the host and a physical address in the memory cell array.
